(19) United States
(12) Patent Application Publication
(10) Pub. No.: US 2015/0026192 A1
(43) Pub. Date: Jan. 22, 2015

(54) SYSTEMS AND METHODS FOR TOPIC FILTER RECOMMENDATION FOR ONLINE SOCIAL ENVIRONMENTS

(71) Applicant: salesforce.com, inc., San Francisco, CA (US)

(72) Inventors: Justin Kamerman, Saint John (CA); Colin Casey, Quispamsis (CA)

(73) Assignee: salesforce.com,inc., San Francisco, CA (US)

(21) Appl. No.: 14/256,909

(22) Filed: Apr. 18, 2014

Related U.S. Application Data
(60) Provisional application No. 61/813,924, filed on Apr. 19, 2013.

(51) Int. Cl. G06F 17/30

(52) U.S. Cl. CPC G06F 17/3053; G06F 17/30699
USPC 707/748

(57) ABSTRACT

The technology disclosed relates to applying collaborative filtering methods to generate topic profiles or filters that can be applied to a social feed. In particular, similar users are identified based on existing topic profiles or aggregations of existing topic profiles. As the user constructs a new topic profile, the word cloud is presented that assists the user in selecting terms to include in the topic profile. Word cloud is constructed from keywords used by the similar users in their topic profiles.

### RELATED APPLICATION

The application claims the benefit of U.S. Provisional Patent Application No. 61/813,924, filed on Apr. 19, 2013 (SALE 1082-1/1175PR). The provisional application is hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

The technology disclosed relates to applying collaborative filtering methods to generate topic profiles or filters that can be applied to a social feed. In particular, similar users are identified based on existing topic profiles or aggregations of existing topic profiles. As the user constructs a new topic profile, the word cloud is presented that assists the user in selecting terms to include in the topic profile. Word cloud is constructed from keywords used by the similar users in their topic profiles.

Social networking has revolutionized the way entities communicate and share information with each other. Online social environments are communities of entities that include users, groups and organizations. These entities share interests and activities and are interested in exploring the interests and activities of other entities. Many social environments provide a collection of various ways for entities to interact, such as feeds, posts, chat, messaging, email, video, voice chat, file sharing, blogging and discussion groups. Social network environments also typically provide tools and communication infrastructures for organizing and managing social networks.

As the volume of information flowing in the online social environments continues to increase, the need for automated tools that can assist entities in receiving information valuable to them also increases. The information overload created by a multitude of information sources makes it difficult for entities to know what piece of information is more suitable, relevant or appropriate to their needs and desires. Also, a substantial portion of entities' web surfing time is spent on separating key information from noise.

Accordingly, it is desirable to provide systems and methods that offer an approach to obtaining relevant online social data suited to a user's particular needs. An opportunity arises to provide a user with relevant, streamlined social media data based on the user's needs and preferences.

### BRIEF DESCRIPTION OF THE DRAWINGS

FIG. 1 shows an example collaborative filtering environment for construction of a social feed filter.

FIG. 2A depicts one implementation of clustering users by social feed filters.

FIG. 2B depicts one implementation of constructing a word cloud for representing keyword text data.

FIG. 3A illustrates auto-completion of individual keywords.

FIG. 3B illustrates a conjunction word cloud.

FIG. 3C illustrates a disjunction word cloud.

FIG. 3D illustrates a negation word cloud.

FIG. 4 is a block diagram of an example computer system to construct social feed filters using collaborative filtering.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The technology disclosed relates to applying collaborative filtering methods to generate topic profiles or filters that can be applied to a social feed. In particular, similar users are identified based on existing topic profiles or aggregations of existing topic profiles. It has the user constructs a new topic profile, the word cloud is presented that assist the user in selecting terms to include in the topic profile. Word cloud is constructed from keywords used by the similar users in their topic profiles.

Examples of systems, apparatus, and methods according to the disclosed implementations are described in a sports query context. The examples of sports queries are being provided solely to add context and aid in the understanding of the disclosed implementations. In other instances, queries may relate to promotional campaigns, current events, perspective customers, etc. Other applications are possible, such that the following examples should not be taken as definitive or limiting either in scope, context or setting. It will thus be apparent to one skilled in the art that implementations may be practiced in or outside the sports query context.

The described subject matter is implemented by a computer-implemented system, such as a software-based system, a database system, a multi-tenant environment, or the like. Moreover, the described subject matter can be implemented in connection with two or more separate and distance computer-implemented systems that cooperate and communicate with one another. One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

### Social Filter Feed Construction Environment

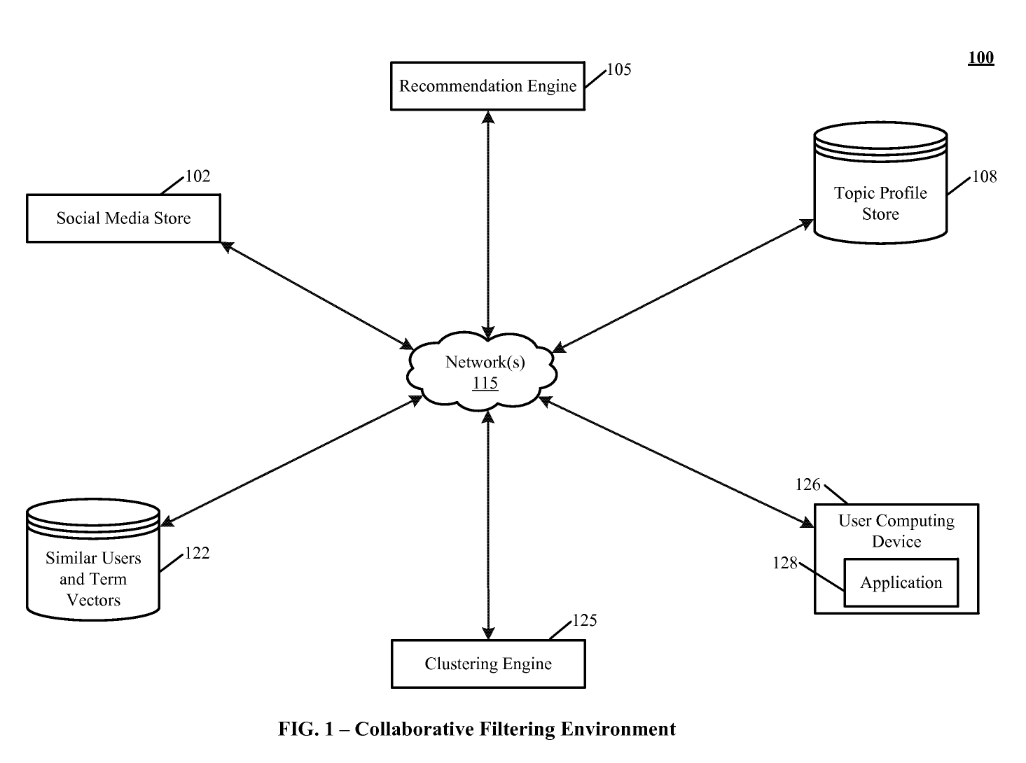

FIG. 1 shows an example collaborative filtering environment 100 for construction of a social filter feed. FIG. 1 shows that environment 100 can include a social media monitoring tool 102 such as Radian 6 provided by Salesforce.com, recommendation engine 105, network(s) 115, clustering engine 125, topic profile store 108, similar users and term vectors store 122, user computing device 126, and user application 128. In some implementations, the engines can be of varying types including workstations, servers, computing clusters, blade servers, server farms, or any other data processing systems or computing devices.

Social media monitoring tool 102 processes live and stored feeds from varying social media platforms. It applies topic profiles to filter the feeds and return data collected from the online conversations that reflect how a particular brand, product or service is regarded amongst users in the online community. Social media monitoring tool 102 uses combinations of keywords that define topic profiles that a client wishes to monitor. The social media monitoring tool 102 is applied to the social media platforms. In some implementations, social media monitoring tool 102 monitors Twitter® and updates the search results from new Tweets that match the user's criteria. Social media monitoring tool 102 also can monitor websites, blogs, and forums. The results of the keyword surveillance can be delivered periodically or in real time. The collected data is presented to the user in a variety of customizable formats.

Topic profile store 108 holds topic profiles used as social feed filters. Construction of social media topic profiles involves creating an expression of filter terms. This may be a Boolean expression, a regular expression, or any other pattern description. The topic profile expression can appear in a social media feed, such as the users own data feed. Construction of topic profiles typically involves trial and error: too inclusive a profile yields too much data and too restrictive, too little. Informal review of topic profiles indicates that profiles in related industries or commercial sectors often share keyword filter terms.

When constructing topic profiles, users enter at least some keywords via user computing device 126 and application 128. Computing device 126 can be laptop computer, desktop computer, a workstation, mobile device, a personal device such as glasses, or any other form of computing device. The application may be a browser such as Chrome, Internet Explorer, Firefox, Safari, and the like, or an application separate from a browser.

The clustering engine 125 populates a similar users and term vectors store 122 in preparation for the recommendation engine 105 to interact with the user to provide recommended additional keywords, as the user enters keywords. The clustering engine 125 uses aggregated term vectors corresponding to individual users, to projects or to clients. For instance, all of the topic profiles for a first user can be aggregated to form a term vector. Or, topic profiles for a project involving multiple individuals can be aggregated to form a term vector. Or, all of the topic profiles for a small company can be aggregated to form a term vector. A multiplicity of term vectors for individuals, projects and/or clients are subjected to similarity clustering. Any of the existing similarity calculations can be applied. For instance, Pearson correlation coefficients can be calculated, Euclidean distances can be calculated, cosines of angles between term vectors can be calculated, or other less common similarity measures such as a Manhattan walking distance can be calculated. The similarity matrix is populated with calculated similarity measures between pairs of users. The resulting calculations are used to select a predetermined number of similar users. The similar users and term vectors store 122 can be populated with the results of selecting similar users and with the term vectors for users. Similar users can be linked to their term vectors. The term vector for a particular user, who may be similar to 1000 other users, can be referenced and stored a single time.

During creation of topic profiles, the recommendation engine 105 applies collaborative filtering to suggest terms. Term vectors or topic profiles of identified similar users are consulted and keywords to suggest are identified, as further described below. Both positive keywords and negations, such as “not football”, are treated as keywords when preparing recommendations. Contributions of words from various users can be weighted in some proportion to the degree of similarity between the contributor and the user who is constructing the new topic filter. The proportionality can be linear proportional, logarithmic proportional, polynomial proportional or some other suitable proportionality. Recommended keywords can be presented as word clouds with visual coding.

Scoring of keywords to recommend can be normalized to take into account bias arising from the number of topic filters aggregated together, so that 100 instances of a particular keyword in a first term vector does not outweigh five instances of a different, but more important keyword in a second term vector. For instance, a term frequency/inverse document or domain frequency normalization can be applied.

In a term vector, keywords can be stemmed to increase matrix density. During construction of the vector, original word forms can be stored and ranked according to their frequency across the corpus. When terms are recommended to users, the stemmed form can be mapped to the most frequent original form or to a grammatical form that resembles other terms in the topic filter.

In some embodiments, the terms may be provided by a database or an application user interface. The images depicted by clustering engine 125 are generated by a processor and computer readable storage medium and displayed to the user. The visual layout of the images may vary according to frequency of the occurrence of the text, in the form of a weighted list. In some implementations a word cloud or tag cloud is used to visually represent keyword text data, and the importance of each keyword text item is depicted by varying the size and/or color of the keyword text font. In this instance, the tag cloud is constructed using inline HTML elements.

The similar users and term vectors data 122 can be regenerated periodically to incorporate new topic profiles and adjustments to existing topic profiles

In general, topic profiles can be applied to a feed that is a combination (e.g. a list) of feed items. A feed item or feed element can include information about a user of the database referred to as profile feed or about a record referred to as record feed. A user following the user or record can receive the associated feed items. The feed items from all of the followed users and records can be combined into a single feed for the user.

In some implementations, an information feed in the context of a social network can be a collection of information selected from the social network for presentation in a user interface. The information presented in the information feed can include entries posted to a user's wall or any other type of information accessible within the social network. For example, a user's news feed can include text inputs such as comments (e.g., statements, questions, emotional expressions), responses to comments (e.g., answers, reactionary emotional expressions), indications of personal preferences, status updates, and hyperlinks. As another example, a news feed can include file uploads, such as presentations, documents, multimedia files, and the like.

In some implementations, a feed item can be a message, post, update stream, and/or a story (also called a feed tracked change). A feed can be a combination of messages and stories. Messages can include text created by a user, and other data as well. Examples of messages include posts, status updates, likes, replies, shares, and comments. Messages can be created for a user's profile or for a record. Posts can be created by various users, potentially any user, although some restrictions can be applied. As an example, posts can be made to a wall section of a user's profile (which can include a number of recent posts) or a section of a record that includes multiple posts. The posts can be organized in chronological order. In contrast to a post, a status update changes a status of a user and is made by that user. Other similar sections of a user's profile can also include an “About” section. A record can also have a status, whose update can be restricted to the owner of the record. The owner can be a single user, multiple users, or a group. In other implementations, there is only one status for a record.

In some implementations a comment can be made on any feed item. In another implementation, comments can be organized as a list explicitly tied to a particular story, post, or status update. In this implementation, comments may not be listed in the first layer (in a hierarchical sense) of feed items, but listed as a second layer branching from a particular first layer feed item.

In some implementations, the feed can include a story which is data representing an event, and can include text generated by the database system in response to the event. In one implementation, the data can initially be stored, and then the database system can later use the data to create text for describing the event. Both the data and/or the text can be a story.

In some implementations, the social media feed can be shared among a group, which is a collection of users. In other implementations, the group can be defined as users with a same or similar attribute, or by membership. In one implementation a group feed can include any feed item about any user in a group. In another implementation, a group feed can include feed items that are about the group as a whole. In one implementation, the feed items for a group are only posts and comments.

In one implementation, the feed items for a profile feed can be posts and comments that other users make about or send to the particular user, and status updates made by the user. Such a profile feed can be displayed on a page associated with the particular user. In another implementation, feed items in a profile feed can include posts made by the particular user and feed tracked changes (stories) initiated based on actions of the particular user.

In one implementation, a user can make a comment within a user's news feed. Such a comment can propagate to the appropriate profile feed or record feed, and then to the news feeds of the following users. Thus, feeds can include what people are saying, as well as what they are doing. In one aspect, feeds are a way to stay up-to-date (e.g., on users, opportunities, etc.) as well as an opportunity to reach out to co-workers/partners and engage them around common goals. In some implementations, a feed item can include one or more actionable selections implemented to interact with the record. The one or more actionable selections can be actionable buttons providing a reference to the publisher. Selecting one of the actionable selections can cause the publisher to be operable to receive information associated with the record for record updates. For instance, if the record is a case, one of the actionable selections can enable the user to send an email to resolve the case via the publisher.

### Flowcharts

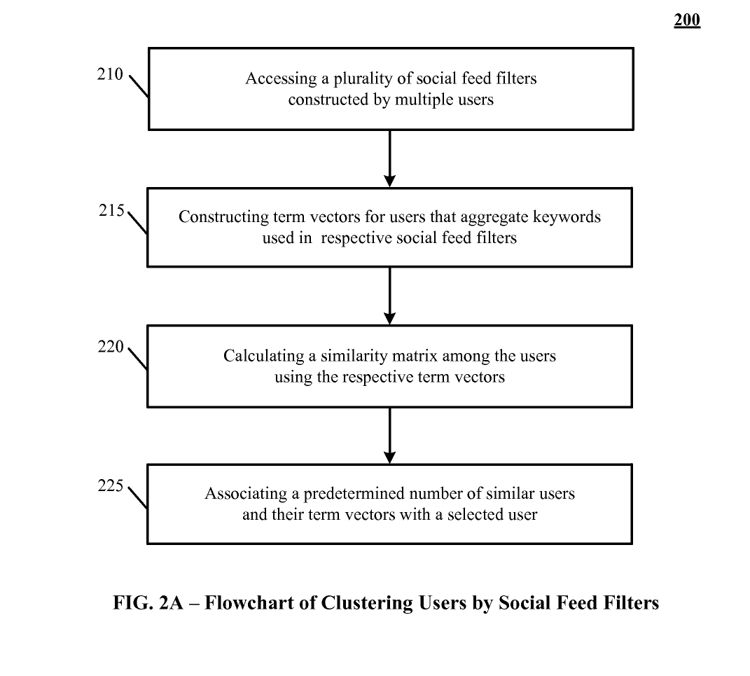

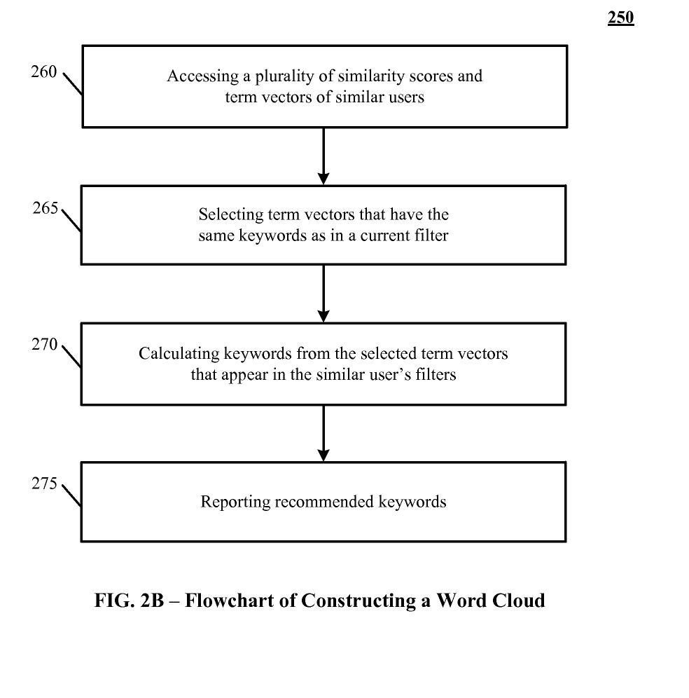

FIG. 2A depicts one implementation 200 of clustering users or other entities by their aggregated topic profiles or social feed filters. For convenience, the flow charts described in this section are described with reference to assisting users, such as the collaborative filtering environment illustrated in FIG. 1. It should be understood that other system elements can be used to implement the method and that the method discloses technology that is not necessarily tied to the system elements used for convenience of description. Moreover, some implementations will combine the steps described in the single steps or may split a single step into multiple steps. Some results may be either pre-calculated or calculated on demand.

At action 210, clustering engine 125 accesses a plurality of topic profile or social feed filters constructed by multiple users from topic profile store 108.

At action 215, clustering engine 125 constructs term vectors composed of keywords. The topic profiles can be grouped by individual, project, client or some other logical grouping. Groups of topic profiles are aggregated to produce term vectors. Keywords and the term vectors can be stemmed, as described above. Noise words can be eliminated. Aggregation produces term vectors for entities.

At action 220 and as illustrated below in Table 1, clustering engine 125 calculates a similarity matrix among the users or other entities using the respective term vectors constructed at action 215. The similarity matrix correlates the term vectors. As a result, scores are symmetrical across the diagonal and the diagonal represents perfect correlation of the term vector with itself. See Table 1.

TABLE 1
pre-calculating similarity of users

| | User | Similar User A | Similar User B | Similar User C |
|---|---|---|---|---|
| User | 1 | 0 | 0.5 | 0 |
| Similar User-A | 0.5 | 1 | 2 | 0.5 |
| Similar User-B | 0 | 0 | 1 | 2 |
| Similar User-C | 0.5 | 1 | 0 | 1 |

At action 225, clustering engine 125 uses the calculated similarity of term vectors to associate a pre-determined number of similar users and their associated term vectors with a selected user. For instance, a list of similar users is constructed for a particular user. References to the similar users' respective aggregated term vectors can be stored with the list. Alternatively or in addition, references to the similar users stores of topic profiles can be stored.

At the conclusion of clustering users by topic profiles or social feed filters, the recommendation engine 105 can be invoked to assist with the construction of a new topic profile.

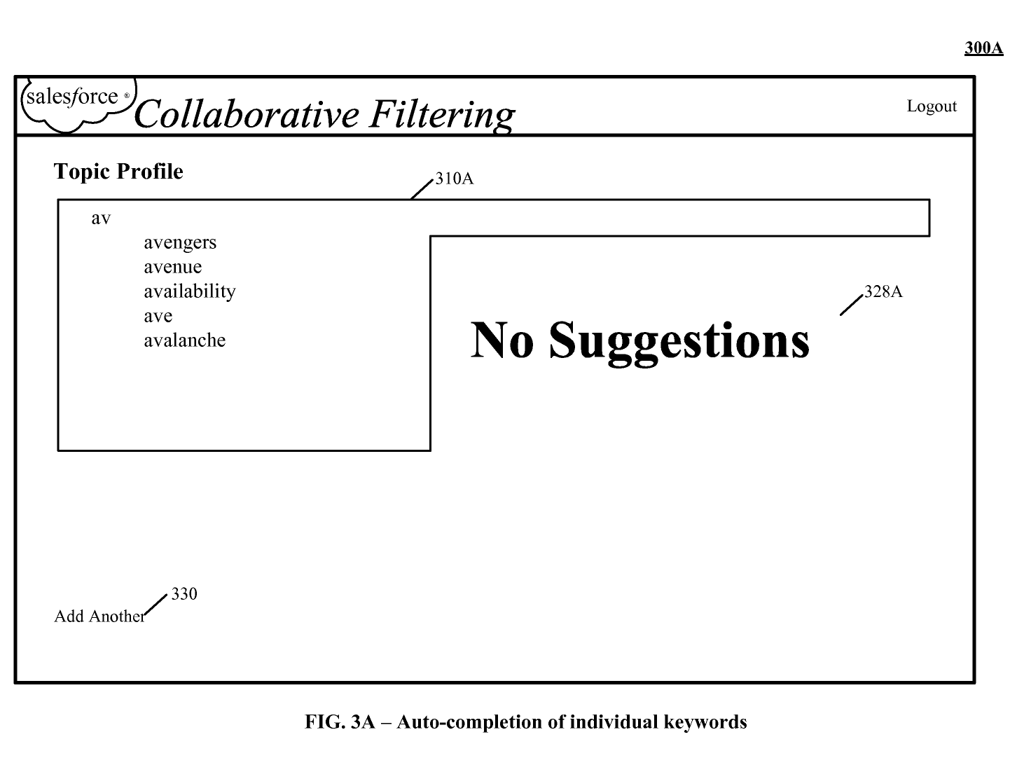

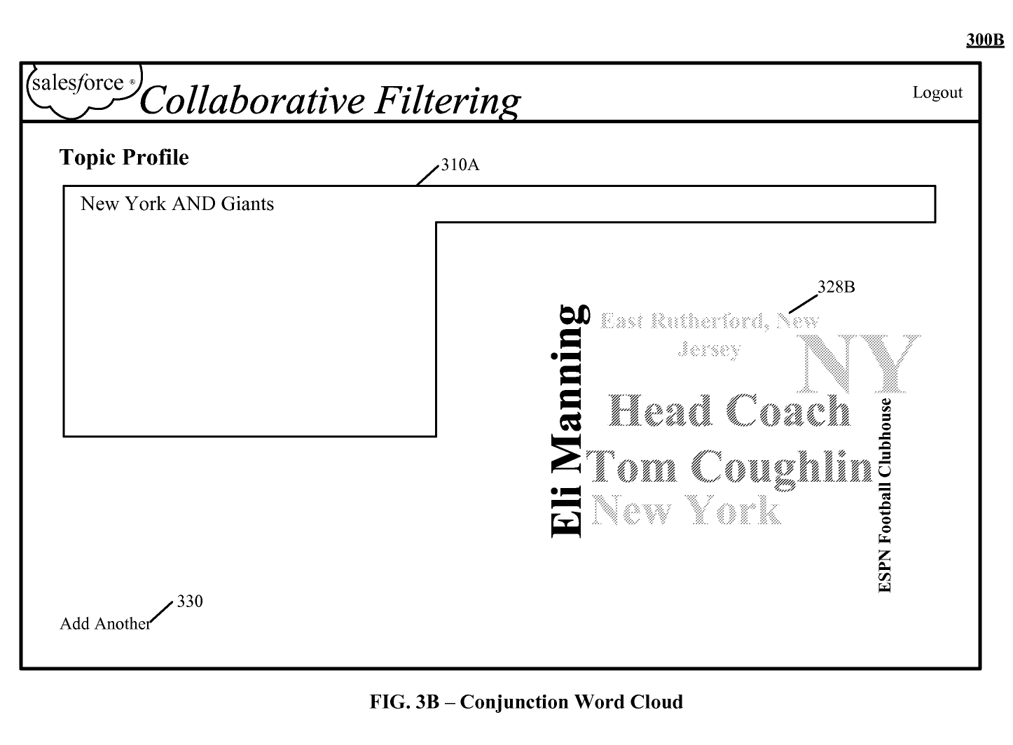

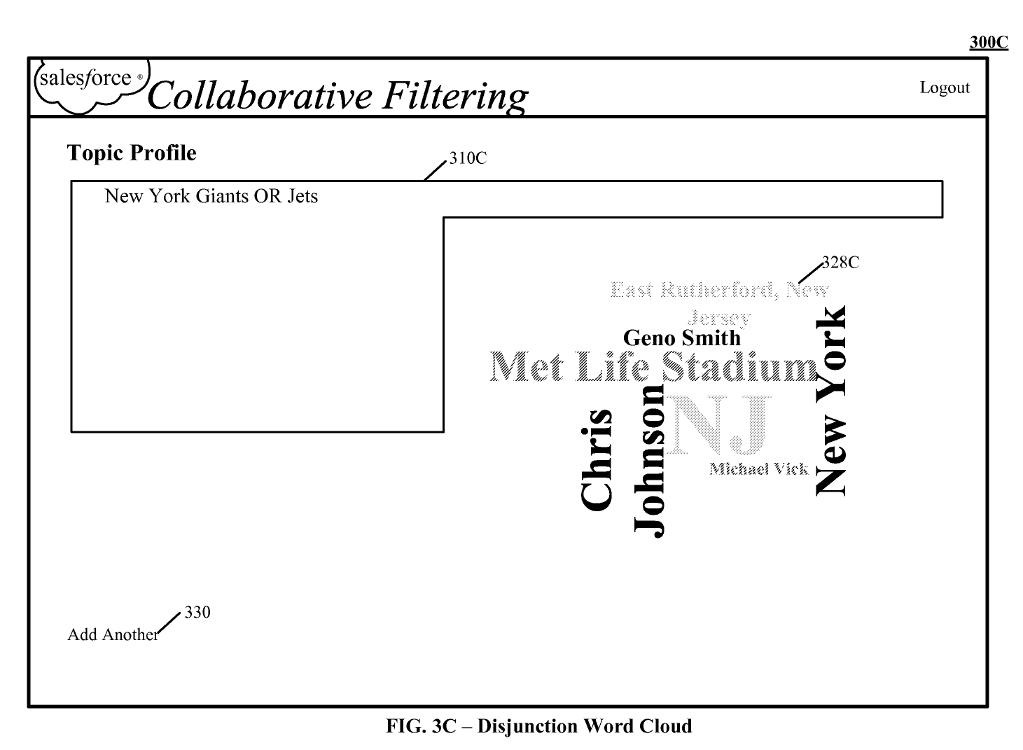

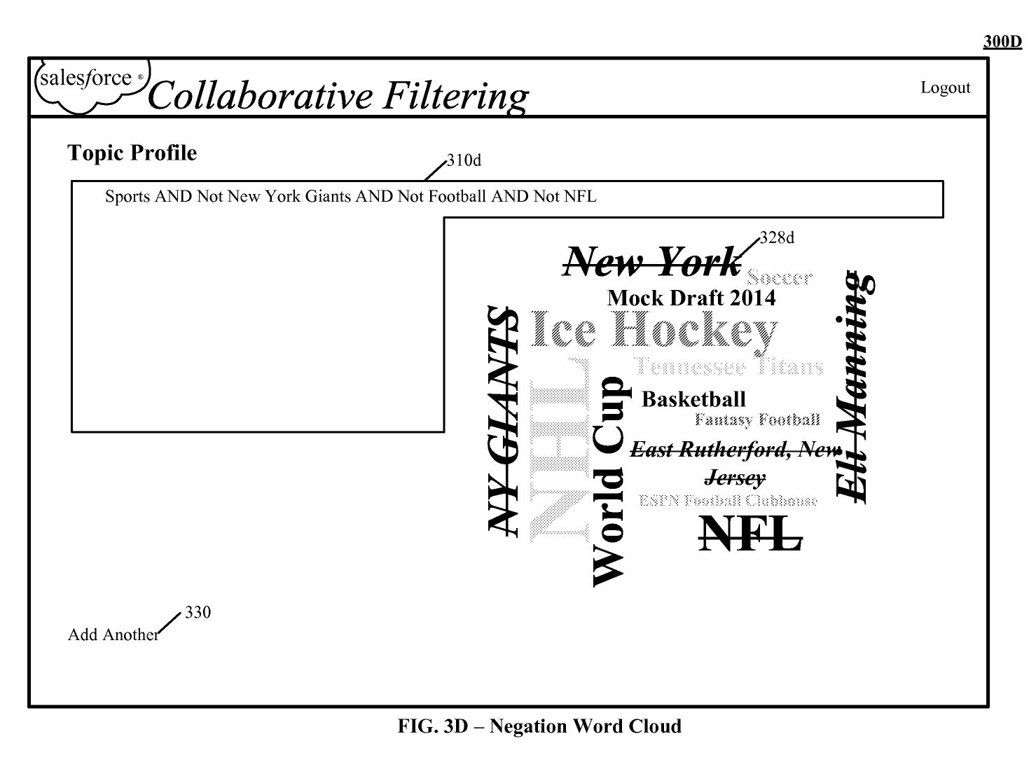

FIG. 2B depicts one implementation 250 of constructing a word cloud that identifies positive and negated keywords for potential inclusion in the topic filter under construction. At action 260, recommendation engine 105 accesses a plurality of similarity scores and term vectors of similar users. In the tables below, we walk through an overly simplified example that provides one implementation of selecting keywords and negated keywords for inclusion in word cloud. Another example is found in FIGS. 3A-3D. These examples are generally drawn from the provisional application that is incorporated by reference. The examples use sensible keywords, as an improvement on the provisional application.

Table 2 presents an example of a user who has entered the word “cat” during preparation of a topic profile. Three similar users A-C have term vectors with just three keywords, “cat”, “dog”, and “fish”. In practice, many more users would be involved and term vectors would be much longer. The similar users in this table may have been selected by the clustering engine 125.

TABLE 2
records of similar users

| | Cat | Dog | Fish |
|---|---|---|---|
| User | 1 | 0 | 0 |
| Similar User-A | 1 | 2 | 0 |
| Similar User-B | 0 | 1 | 2 |
| Similar User-C | 1 | 0 | 1 |

At action 265, recommendation engine 105 selects term vectors that include whatever keywords are found in the current filter to be constructed by the user. In this example, the user constructing the current filter has entered the word “cat”. In Table 2, the term vectors for user-A and user-C include the keyword term “cat” with user. Thus, users A and C are reflected in subsequent tables.

At action 270, recommendation engine 105 calculates keywords to recommend from the term vectors selected at action 265 that appear in the similar user's filters. Keyword scoring is described in several tables that follow.

One similarity calculation that can be applied is in the following form:

Keyword similarity score=Σ((keyword score (similar user, user)*user score(similar user, user)), summed over similar users.

Data for term vectors of similar user-A and similar user-C, both of which use the word “cat” and user term vector similarity are set forth in Table 3.

TABLE 3
records of term vectors and similarity scores of similar users

| | | | | User Term Vector |
|---|---|---|---|---|
| | Cat | Dog | Fish | Similarity |
| User | 1 | 0 | 0 | Not applicable |
| Similar User-A | 1 | 2 | 0 | 0.5 |
| Similar User-C | 1 | 0 | 1 | 0.1 |

Keywords scores are calculated for the keywords in the term vectors, taking into account frequency of keyword appearance and user similarity of a candidate term vector to the user's term vector. Using the user term vector similarity scores above, the formula becomes:

Keyword score=((keyword score (similar user-A, user)*0.5)+(keyword score (similar user-C, user)*0.1)

TABLE 4
weighting terms of term vectors

| | Cat | Dog | Fish |
|---|---|---|---|
| Similar User-A | 0.5 | 1 | 0 |
| Similar User-C | 0.1 | 0 | 0.1 |
| | 0.6 | 1.0 | 0.1 |

In this example, scores for “cat” have been aggregated, even though that is the keyword that the user entered, so it will not be suggested as the next keyword to use.

At action 275, recommendation engine 105 selects keywords from among the weighted term vectors to report as suggested keywords for constructing a new social feed filter. For instance, words are reported in a word cloud. In Table 5, “dog” is much more closely associated with “cat” than is “fish”.

In some implementations term frequency-inverse domain frequency (TF-IDF) may be used to further reflect the significance of a particular keyword within a set of data. TF-IDF is a weighting scheme in which the value increases proportionally to the number of times the keyword appears within a particular document, and is then offset by the frequency of the keyword as it appears across the corpus. After the similarity calculation is completed and the suggested keywords are ascertained, the TF-IDF may be performed as an additional enhanced calculation in order to elevate the rankings of those keywords which have already been weighted and aggregated.

### User Interfaces for Social Feed Filter Construction

FIGS. 3A-3D illustrate user interfaces that may be used in a collaborative filtering environment when constructing a new topic profile or social filter feed. FIG. 3A illustrates auto-completion of individual keywords. At 310A, in response to the user's keyword text entry “av”, recommendation engine 105 employs auto-completion to help suggest recommended words that match “av”. The auto-completion function is executed using conventional methods. Auto-completed terms can be immediately suggested as the user enters keywords. Boolean expressions can be used to define the order, grouping, and logic of a social feed filter, including for example:

Conjunction—A and B

Disjunction—B or C

Grouping—(one and two and three)

Phrases—“The Incredible Hulk” or “Bruce Banner”

Negation—Peace and not War

In addition to speeding up entry of the topic profile or social feed filter keywords, basic keyword completion can be provided by recommendation engine 105. Recommendation engine 105 is executed to retrieve suggested social feed filter terms in construction of the new social feed filter and displayed to the user so that relevance and positive/negative attributes are easily identifiable. In some implementations, multiple social feed filters can be easily created and edited.

At 310A, the recommended keyword list includes “avengers”, “avenue”, “availability”, “ave”, and “avalanche” where each word begins with “av”. The recommended keywords are each associated with previously constructed social feed filters stored in the system. At 328A, because the recommended keywords listed are not matched to any of the previously constructed social feed filters stored in the system, recommendation engine 105 did not return any matching social feed filter data to the user, hence the message “no suggestions.” At 330, the user is prompted to enter additional keywords for the system to continue searching in order to build more social feed filters.

FIG. 3B illustrates a word cloud responsive to conjunction logic. User interface 310B shows that a user enters the search terms “New York and Giants” using the Boolean search term “and”. In response to the user's search, recommendation engine 105 returns recommended keywords in a visual word cluster or word cloud. The word cloud is used to guide users in selecting relevant or additional terms to consider using in the construction of their own topic profiles. Other implementations may include different visual depictions such as a ranked list of the recommended key words, a pie chart, or a bar graph chart. Each recommended keyword shown is associated with a previously constructed social feed filter stored in the system. The word cloud contains text and phrases associated with “New York Giants” such as the team's practice location of East Rutherford, N.J.; head coach, Tom Coughlin, and key player Eli Manning. Each word or phrase in the word cloud is depicted in a distinct way. For example, words having larger text sizes occur within the constructed feed filters with a greater frequency. In addition, the color of the text may also be varied to indicate other data such as the original source from where the social feed filter derived its data. For example, social feed filters derived from Twitter® data may be depicted with one particular color while social feed filters derived from Facebook® data may be depicted with a different color.

FIG. 3C illustrates a word cloud responsive to disjunction logic. User interface 310C shows that a user enters the search terms “New York Giants or Jets” using the Boolean search term “or”. In response to the user's search, recommendation engine 105 returns recommended keywords in a visual word cluster or word cloud. Each recommended keyword shown is associated with a previously constructed social feed filter stored in the system. The word cloud contains text and phrases associated with both “New York Giants” and “New York Jets”, such as the team's home location—Met Life Stadium in New Jersey; head coach, Geno Smith; and key players Chris Johnson and Michael Vick. The system returns data associated with both “New York Giants” and “New York Jets”, which is reflected in the word cloud which displays a mixture of data for both teams.

FIG. 3D illustrates a word cloud responsive to negation logic. User interface 310D shows that a user enters an affirmative search term “Sports”. In addition, the user also enters “not New York Giants” and “not football” and “not NFL” as the remaining search criteria. In response to the user's search, recommendation engine 105 returns recommended keywords in a visual word cluster or word cloud that are least likely to be associated with “New York Giants” including “ice hockey”, “NHL”, “soccer”, “world cup”, and basketball. Those terms which are in fact associated with “New York Giants”, “football”, and “NFL” are shown in the word cloud 328D with a strikethrough and italicized designation in order to show a distinct contrast from the results shown for the affirmative search term “Sports”.

### Computer System

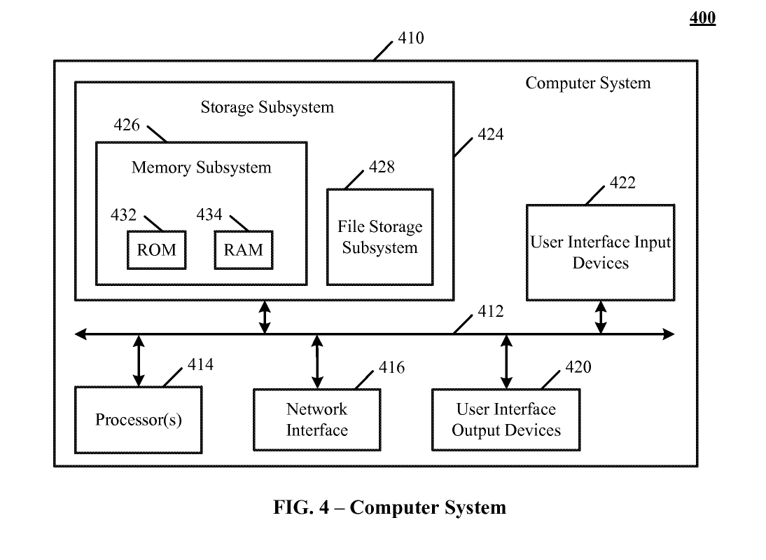

FIG. 4 is a block diagram of an example computer system 400 to construct social feed filters using collaborative filtering. FIG. 4 is a block diagram of an example computer system, according to one implementation. Computer system 410 typically includes at least one processor 414 that communicates with a number of peripheral devices via bus subsystem 412. These peripheral devices can include a storage subsystem 424 including, for example, memory devices and a file storage subsystem, user interface input devices 422, user interface output devices 420, and a network interface subsystem 416. The input and output devices allow user interaction with computer system 410. Network interface subsystem 416 provides an interface to outside networks, including an interface to corresponding interface devices in other computer systems.

User interface input devices 422 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 410.

User interface output devices 420 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules and methods described herein. These software modules are generally executed by processor 414 alone or in combination with other processors.

Memory 426 used in the storage subsystem can include a number of memories including a main random access memory (RAM) 434 for storage of instructions and data during program execution and a read only memory (ROM) 432 in which fixed instructions are stored. A file storage subsystem 428 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 428 in the storage subsystem 424, or in other machines accessible by the processor.

Bus subsystem 412 provides a mechanism for letting the various components and subsystems of computer system 410 communicate with each other as intended. Although bus subsystem 412 is shown schematically as a single bus, alternative implementations of the bus subsystem can use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as one example. Many other configurations of computer system 410 are possible having more or fewer components than the computer system depicted in FIG. 4.

### Particular Implementations

In one implementation, the technology disclosed includes a method for constructing a social feed filter. The method includes accessing a plurality of social feed filters constructed by multiple users, and the social filters apply to social feeds of respective users' online social profiles. The method further includes constructing term vectors for each of the users that aggregate keywords used in at least a selected subset of their respective social feed filters. The method further includes calculating a similarity matrix among the users that scores similarity of the respective term vectors and storing in a memory system for each of the users at least part of the respective term vectors, an identification of a predetermined number of similar users who were calculated in the similarity matrix to have similar term vectors and the similarity scores of the similar users.

This method and other implementations of the technology disclosed can each optionally include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as social environments, collaborative filtering, topic profiles, and word clouds.

The method further includes recommending suggested keywords based on the similar term vectors of the similar users, for consideration by a first user while the first user constructs the social feed filter.

The method further includes generating for display the word cloud for consideration by a first user while the first user constructs the social feed filter.

The method includes sizing and visual coding of the keywords in the word cloud is a function of frequencies of occurrence of the keywords in the social feed filters of the similar users.

In another implementation, a method is described for constructing a social feed filter. The method includes receiving at least one keyword entered by a first user and a first user identifier to create a social feed filter that applies to one or more social feeds of the first user's online social profiles. The method also includes using the first user identifier, retrieving from a memory system records of a plurality of similar users who were pre-calculated to have similar term vectors, wherein the pre-calculated similarity is based at least in part on similarity of aggregate key word vectors constructed from respective social feed filters of the first user and the similar users.

The method further includes retrieving from a memory system records of a plurality of similar users who were pre-calculated to have similar term vectors, where the pre-calculated similarity is based in part on similarity of aggregate key word vectors constructed from respective social feed filters of the first user and the similar users. The method further includes comparing in the term vectors based on respective similarity scores of the similar users and aggregating the compared terms. The method further includes selecting among the aggregated terms keywords to report as suggested keywords for consideration by the first user while constructing the social filter and responding to the received keyword with at least some of the selected keywords.

The method further includes representing aggregated terms with least similarity scores as negation expressions and selecting among the aggregated terms with least similarity scores keywords to report as suggested negation keywords.

The method further includes that suggested keywords are immediately displayed in response to the at least one keyword entered by the first user.

The method includes generating for display suggested search criteria that connects a plurality of suggested keywords using Boolean operators.

In another implementation, a system of initializing a system to guide a user in constructing a social feed filter is described. The system includes a processor and a computer readable storage medium storing computer instructions that, when executed on a processor, cause the processor to access a plurality of social feed filters constructed by multiple users, wherein the social filters apply to social feeds of respective users' online social profiles. The instructions further cause the processor to construct term vectors for each of the users that aggregate keywords used in at least a selected subset of their respective social feed filters. The instructions further cause the processor to implement a similarity matrix among the users that scores similarity of the respective term vectors and store in a memory system for each of the users at least part of the respective term vectors, an identification of a predetermined number of similar users who were calculated in the similarity matrix to have similar term vectors and the similarity scores of the similar users.

The instructions further cause the processor to recommend suggest keywords, based on the similar term vectors of the similar users, for consideration by a first user while the first user constructs the social feed filter.

The instructions further cause the processor to implement construction of a word cloud that ranks the keywords based on aggregated frequencies of occurrence of the keywords in the social feed filters of the similar users.

The instructions further cause the processor to implement sizing and visual coding of the keywords in the word cloud is a function of frequencies of occurrence of the keywords in the social feed filters of the similar users.

The instructions further cause the processor to generate for display the word cloud for consideration by a first user while the first user constructs the social feed filter.

In another implementation, a system of guiding a user in construction a social feed filter is described. The system includes a processor and a computer readable storage medium storing computer instructions that, when executed on a processor, cause the processor to receive at least one keyword entered by a first user and a first user identifier to create a social feed filter that applies to one or more social feeds of the first user's online social profiles. The instructions further cause the processor to use the first user identifier, retrieving from a memory system of records of a plurality of similar users who were pre-calculated to have similar term vectors, wherein the pre-calculated similarity is based at least in part on similarity of aggregate key word vectors constructed from respective social feed filters of the first user that the similar users. The instructions further cause the processor to aggregate key word vectors constructed from respective social feed filters of the first user and the similar users. The instructions further cause the processor to further retrieve from the memory system a plurality of term vectors and similarity scores of the similar users. The instructions further cause the processor to compare terms in the term vectors based on respective similarity scores of the similar users and aggregating the compared terms. The instructions further cause the processor to select among the aggregated terms keywords to report as suggested keywords for consideration by the first user while constructing the social filter, and responds to the received keyword with at least some of the selected keywords.

The instructions further cause the processor to represent aggregated terms least similarity scores as negation expressions and selecting among the aggregated terms with least similarity scores keywords to report as suggested negation keywords.

The instructions further cause the processor to immediately display suggested keywords in response to the at least one keyword entered by the first user.

The instructions cause the processor to generate for display suggested search criteria that connects a plurality of suggested keywords using Boolean operators.

What is claimed is:

1. A computer-implemented method of initializing a system to guide a user in constructing a social feed filter, the method including:
accessing a plurality of social feed filters constructed by multiple users, wherein the social feed filters apply to social feeds of respective users' online social profiles;
constructing term vectors for each of the users that aggregate keywords used in at least a selected subset of their respective social feed filters;
calculating a similarity matrix among the users that scores similarity of the respective term vectors; and
storing in a memory system for each of the users at least part of the respective term vectors, an identification of a predetermined number of similar users who were calculated in the similarity matrix to have similar term vectors and the similarity scores of the similar users.

2. The method of claim 1, further including recommending suggested keywords, based on the similar term vectors of the similar users, for consideration by a first user while the first user constructs the social feed filter.

3. The method of claim 1, further including constructing a word cloud that ranks the keywords based on aggregated frequencies of occurrence of the keywords in the social feed filters of the similar users.

4. The method of claim 3, wherein size and visual coding of the keywords in the word cloud is a function of frequencies of occurrence of the keywords in the social feed filters of the similar users.

5. The method of claim 3, further including generating for display the word cloud for consideration by a first user while the first user constructs the social feed filter.

6. A computer-implemented method of guiding a user in constructing a social feed filter, the method including:
receiving at least one keyword entered by a first user and a first user identifier to create a social feed filter that applies to one or more social feeds of first user's online social profiles;
using the first user identifier, retrieving from a memory system records of a plurality of similar users who were pre-calculated to have similar term vectors, wherein the pre-calculated similarity is based at least in part on similarity of aggregate key word vectors constructed from respective social feed filters of the first user and the similar users;
further retrieving from the memory system a plurality of term vectors and similarity scores of the similar users;
comparing terms in the term vectors based on respective similarity scores of the similar users and aggregating the compared terms;
selecting among the aggregated terms keywords to report as suggested keywords for consideration by the first user while constructing the social filter; and
responding to the received keyword with at least some of the selected keywords.

7. The method of claim 6, further including representing aggregated terms with least similarity scores as negation expressions and selecting among the aggregated terms with least similarity scores keywords to report as suggested negation keywords.

8. The method of claim 6, wherein suggested keywords are immediately displayed in response to the at least one keyword entered by the first user.

9. The method of claim 6, further including generating for display suggested search criteria that connects a plurality of suggested keywords using Boolean operators.

10. A system of initializing a system to guide a user in constructing a social feed filter, the system including:
a processor;
computer instructions causing the computer to implement:
accessing a plurality of social feed filters constructed by multiple users, wherein the social filters apply to social feeds of respective users' online social profiles;
constructing term vectors for each of the users that aggregate keywords used in at least a selected subset of their respective social feed filters;
calculating a similarity matrix among the users that scores similarity of the respective term vectors; and
storing in a memory system for each of the users at least part of the respective term vectors, an identification of a predetermined number of similar users who were calculated in the similarity matrix to have similar term vectors and the similarity scores of the similar users.

11. The system of claim 10, wherein suggested keywords are recommended based on the similar term vectors of the similar users, for consideration by a first user while the first user constructs the social feed filter.

12. The system of claim 10, wherein a word cloud is constructed and ranks the keywords based on aggregated frequencies of occurrence of the keywords in the social feed filters of the similar users.

13. The system of claim 12, wherein size and visual coding of the keywords in the word cloud is a function of frequencies of occurrence of the keywords in the social feed filters of the similar users.

14. The system of claim 12, wherein the word cloud for consideration by a first user while the first user constructs the social feed filter is generated for display.

15. A system of guiding a user in constructing a social feed filter, the system including:
a processor;
computer instructions causing the computer to implement:
receiving at least one keyword entered by a first user and a first user identifier to create a social feed filter that applies to one or more social feeds of first user's online social profiles;
using the first user identifier, retrieving from a memory system records of a plurality of similar users who were pre-calculated to have similar term vectors, wherein the pre-calculated similarity is based at least in part on similarity of aggregate key word vectors constructed from respective social feed filters of the first user and the similar users;
further retrieving from the memory system a plurality of term vectors and similarity scores of the similar users;
comparing terms in the term vectors based on respective similarity scores of the similar users and aggregating the compared terms;
selecting among the aggregated terms keywords to report as suggested keywords for consideration by the first user while constructing the social filter; and
responding to the received keyword with at least some of the selected keywords.

16. The system of claim 15, wherein aggregated terms are represented with least similarity scores as negation expressions and selecting among the aggregated terms with least similarity scores keywords to report as suggested negation keywords.

17. The system of claim 15, wherein suggested keywords are immediately displayed in response to the at least one keyword entered by the first user.

18. The system of claim 15, wherein suggested search criteria that connects a plurality of suggested keywords using Boolean operators are generated for display.
